(19) United States
(12) Patent Application Publication
(10) Pub. No.: US 2016/0258779 A1
(43) Pub. Date: Sep. 8, 2016

(54) Inertial Motion Capture Calibration

(71) Applicant: XSENS HOLDING B.V., Enschede (NL)

(72) Inventors: Jeroen D. Hol, Hengelo (NL); Giovanni Bellusci, Hengelo (NL)

(73) Assignee: XSENS HOLDING B.V., Enschede (NL)

(21) Appl. No.: 14/639,776

(22) Filed: Mar. 5, 2015

(51) Int. Cl. G01C 25/00; G01P 21/00

(52) U.S. Cl. CPC G01C 25/005; G01P 21/00

(57) ABSTRACT

A system and method for accurately estimating orientations between inertial sensing units and the body segments of a multi-segment subject to which they are affixed, and for accurately estimating position vectors from sensing units to joint centers of the corresponding body segments. By using the disclosed system and method magnetometers are not required and SDI (strap down integration) increments may be used as input to estimate the position and orientation of the sensors.

### TECHNICAL FIELD

The present disclosure is related generally to inertial motion capture and, more particularly, to a system and method for inertial motion capture calibration.

### BACKGROUND

It is frequently desired to determine the position of an object, such as a golf club, or of a person, or of a body part such as a golfer's hand, forearm, and so on. Indeed, the uses for motion sensing systems include sports analysis, medical analysis, animation, entertainment, virtual reality and other uses. For such purposes, one or more motion sensors are typically placed on each object or part of interest, and the data from such sensors is collected and processed to provide an indication of position, velocity, acceleration, orientation or other parameters.

Such sensors are typically self-referenced, meaning they provide position or motion data without reference to an external component such as a satellite. Inertial sensors are often used where self-referenced sensors are needed. These sensors operate via internal gyroscopes and accelerometers. While inertial sensor systems can be very accurate, the sensors detect changes in orientation and velocity, rather than sensing orientation, velocity or position directly. As such, there is a need to determine the initial spatial state of the sensor before delta readings can be processed to provide accurate velocity, position and orientation information.

In greater detail, with respect to capturing human motion, inertial motion capture technology works by integrating 3D gyroscope and 3D accelerometer signals to generate orientation and position for each tracked object or human body segment. This is done while ensuring that the calculated orientation and position values remain consistent with any physical constraints, such as, with respect to a human body, the constraint that the body segments remain linked by their joints.

However, in order to achieve good motion tracking performance it is important that the mounting of the sensing unit on each segment is known, both in terms of orientation, typically called sensor-to-segment alignment, and in terms of position, commonly expressed as lever arms. Existing methods used to determine said mounting parameters suffer from severe drawbacks.

For example, the sensor-to-segment alignment method described in U.S. Pat. No. 7,725,279B2 requires that the subject stands motionless in a predefined position, in such a way that the orientation of the segments in a reference frame is known. From stationary accelerometer and magnetometer measurements, the orientation of every sensor is calculated. Taking the difference between the sensor orientation and the segment orientation now gives the sought sensor-to-segment alignment.

The major limitation of this approach lies in the requirement for a homogenous magnetic field at all the sensor positions. When this requirement is not satisfied, the calculated sensor orientations do not share a common reference frame which introduces errors in the sensor-to-segment calibration. While in some cases this might not pose significant limitations for practical use of inertial motion capture, there are many scenarios where this approach cannot be used. Examples include indoor usage, where steel of the construction is known to locally distort the magnetic field by several tens of degrees easily, or usage near medical devices such as prostheses, where moving parts of the construction or actuation currents result in magnetic distortions. Furthermore, if the subject does not assume the exact prescribed posture for any reason, the method gives poor performance.

U.S. Pat. No. 7,725,279B2 also describes a method wherein values for the lever arms are derived from a biomechanical scaling model which provides the length of individual segments, in combination with a predefined sensor mounting, for instance by having the subject wearing a suit. The results of this approach are generally inaccurate and not subject specific. Hence, they result in degraded inertial motion capture performance, which may manifests as incorrect step length, unrealistic motion or physically impossible poses with intersecting limbs.

An alternative method described in the aforementioned patent is to estimate the lever arms from the instantaneous acceleration of a joint connecting two adjoining segments: the measured acceleration vectors from adjoining segments are translated to the joint center and expressed in a common frame, giving equality since the segments cannot separate. Instead of comparing acceleration vectors, which requires known (relative) orientation to express them in a common frame, it is also possible to equate their magnitudes. From a dataset with enough excitation of the segments, the lever arms can be estimated by enforcing either equality to hold for all measurements.

The main limitation of this approach is that the translation of the instantaneous acceleration measurements to the joint centers, which is done using the well-known relation

aⱼₒᵢₙₜ=aₛₑₙₛₒᵣ+\dot{ω}×r+ω×ω×r,

requires the instantaneous angular acceleration \dot{ω}. The instantaneous angular acceleration however is not measured directly; rather, it is derived from the angular velocity measurements of the gyroscopes. Due to its volatile nature and large ranges (a human can easily achieve angular acceleration values over 50000 deg/s² for durations up to several ms), this puts stringent requirements in terms of large bandwidths combined with high sampling rates on both the accelerometers and the gyroscopes. These requirements are not feasible in many applications, including low-power, always on, wireless sensing devices.

Additionally, in many applications it is common to pre-process the signals with SDI as in US2011109438A1 in order to reduce the output rate by converting high-rate angular velocity and acceleration into lower rate orientation increments and velocity increments. In this way, however, instantaneous acceleration and instantaneous angular velocity are lost, which renders these signals useless for lever arm estimation using the approaches previously proposed in art based on translation of instantaneous acceleration.

The present disclosure is directed to systems and methods that can eliminate some of the shortcomings noted in this Background section. However, it should be appreciated that any such benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the prior art. As such, the inventors expressly disclaim this section as admitted or assumed prior art with respect to the discussed details, other than for the existence of the references noted by patent number or application number. For these, the reader is urged to read the relevant reference in its entirety for a full and accurate understanding of that art.

### SUMMARY

In this disclosure, a method for inertial motion capture calibration is disclosed which does not rely on the magnetic field to estimate the sensor-to-segment alignment. Additionally, a method for calibration of lever arms is disclosed which does not require high output rate inertial measurements to work. The two methods can be combined into a simultaneous, subject specific, calibration.

In an embodiment, the disclosed principles provide a method of inertial motion capture calibration with respect to a subject having multiple segments joined by successive joints. Each segment has affixed at least one sensing unit, where each sensing unit contains at least a 3D gyroscope and a 3D accelerometer. The method includes defining unknown 3D orientations between sensing units and the segments they are attached to, collecting 3D accelerometer and 3D gyroscope data from the sensing units, predicting position and orientation trajectories of the sensing units, deriving 3D joint center positions from the position and orientation of two adjoining sensing units attached to corresponding segments, generating 3D joint position constraints by equating 3D joint center positions to the corresponding segments, and updating the sensing unit trajectories by applying the 3D joint position constraints. Furthermore, a set of at least 3N independent segment orientation constraints is generated, each constraint being a scalar function operating on a 3D orientation of a segment at one or more time instants, and using the segment orientation constraints the unknown 3D orientations are estimated.

The subject may be a human body, with limbs, appendages, and so on connected by joints. In a further embodiment, unknown 3D position vectors and sensing unit trajectories are estimated by defining unknown 3D position vectors from the sensing units to corresponding joint centers, collecting 3D accelerometer and 3D gyroscope data from the sensing units, predicting position and orientation trajectories of the sensing units, generating 3D joint position constraints by equating the 3D joint center positions derived from the position and orientation of two adjoining sensing units attached to corresponding segments, and applying the 3D joint position constraints.

Moreover, the 3D accelerometer and 3D gyroscope data may comprise orientation increment and velocity increment signals obtained from pre-processing with SDI (strap down integration).

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic illustration of a human leg consisting of three segments and two joints, with each segment having at least one sensing unit thereon in accordance with an embodiment of the described principles;

FIG. 2 is a usage representation showing stride error;

FIG. 3 is a modular view of an example system for implementing various embodiments of the disclosed principles;

FIG. 4 is a flowchart showing a calibration process of estimating unknown 3D position vectors in accordance with an embodiment of the disclosed principles;

FIG. 5 is a data plot showing lever arm estimation results for SDI inputs using an embodiment of the disclosed principles and a comparison technique;

FIG. 6A is a usage representation showing sensor-to-segment calibration results in accordance with an embodiment of the disclosed principles, with a transparent reference overlay;

FIG. 6B is another usage representation showing sensor-to-segment calibration results in accordance with an embodiment of the disclosed principles, with a transparent reference overlay;

FIG. 7 is a knee joint angle plot showing knee flexion and extension results in accordance with an embodiment of the disclosed principles;

FIG. 8A is a usage schematic showing a pose estimate during normal walk, before calibration in accordance with an embodiment of the disclosed principles, with a transparent reference overlay;

FIG. 8B is a usage schematic showing a pose estimate during normal walk, after calibration in accordance with an embodiment of the disclosed principles, with a transparent reference overlay; and

FIG. 9 is a flowchart showing a process of estimating unknown 3D orientations using segment orientation constraints in accordance with an embodiment of the disclosed principles.

### DETAILED DESCRIPTION

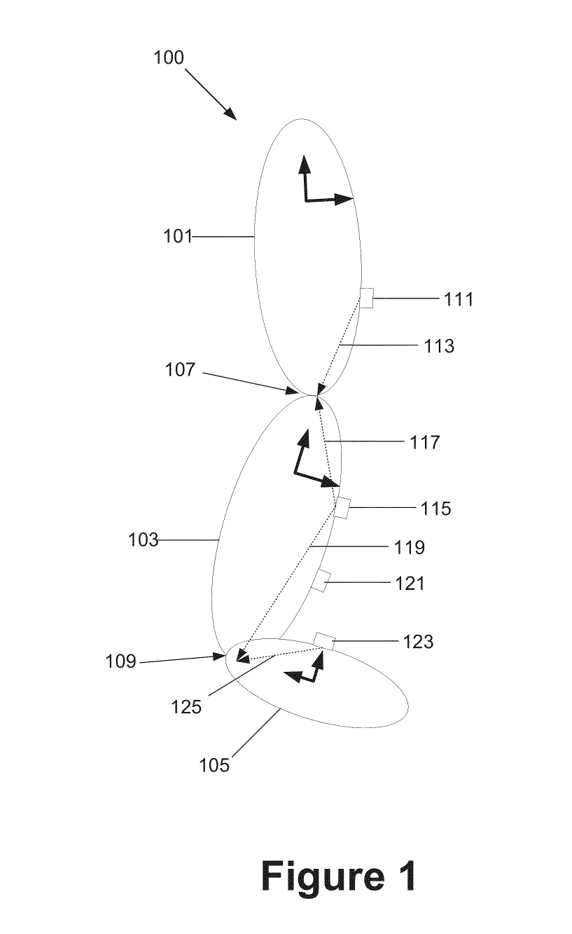

Turning now to a more detailed discussion in conjunction with the attached figures, FIG. 1 is a schematic illustration of a human leg consisting of three segments and two joints, with each segment having at least one sensing unit thereon in accordance with an embodiment of the described principles. More generally, for purposes of inertial motion capture, the body of the subject, or part of it, is assumed to consist of N segments that are linked to each other using joints. Additionally, each segment is instrumented with at least one sensing unit, containing at least a 3D gyroscope and a 3D accelerometer.

In the illustrated figure, the multi-segment object of interest 100 is a human leg and foot. This object of interest 100 is shown as three segments 101, 103 and 105, with segment 101 being the upper leg, segment 103 being the lower leg, and segment 105 being the foot. A first joint 107 (e.g., the knee) joins segment 101 with segment 103, and a second joint 109 (e.g., the ankle) joins segment 103 with segment 105. The joints 107 and 109 may be modeled as point pivots or, in alternative embodiment, without limiting the applicability of the method, as hinge joints or ball-in-socket joints.

In the illustrated embodiment, the upper leg segment 101 is instrumented with a first inertial sensing unit 111. The manner of affixing the first inertial sensing unit 111 to the segment 101 is not critical, but should be done in a manner that minimizes relative movement between the first inertial sensing unit 111 and the underlying skeletal structure. Various methods of affixing the first inertial sensing unit 111 to the first segment 101 include affixing with an adhesive, affixing with a band or strap, affixing via a pocket in a garment and so on. The first inertial sensing unit 111 has a lever arm 113 to the first joint 107.

In the illustrated embodiment, the lower leg segment 103 is instrumented with a second inertial sensing unit 115. The manner of affixing the second inertial sensing unit 115 to the segment 103 may be by any of the means discussed above or otherwise. The second inertial sensing unit 115 has a lever arm 117 to the first joint 107 and a lever arm 119 to the second joint 109.

A third inertial sensing unit 121 is shown affixed to the lower leg segment 103 as well. This is simply to illustrate that more than one inertial sensing unit may be used for a given segment.

Finally, the foot segment 105 is instrumented with a fourth inertial sensing unit 123. The manner of affixing the fourth inertial sensing unit 123 to the segment 105 may be by any of the means discussed above or otherwise. The fourth inertial sensing unit 123 has a lever arm 125 to the second joint 109.

To estimate the motion of the subject instrumented as in FIG. 1, the 3D gyroscope and 3D accelerometer signals of each inertial sensor unit are integrated to generate orientation and position values respectively, for each sensing unit, while ensuring that the orientation and position values for the segments are consistent with the physical joint constraints.

In other words, the orientation and position values for each segment must be such that as a whole, the jointed model remains intact at the joints. The lever arms between sensing units and joints are used, in an embodiment, to link the segments (that is, to ensure that the 3D joint centers from different segments at the same joint lie at the same point).

The estimated motion of the subject will inevitably drift in both position and orientation due to error integration and the absence of absolute orientation and position aiding sources. However, the individual sensor kinematics are constrained and coupled by the joints. In particular, under mild conditions of motion, e.g. an acceleration caused by sitting in an accelerating car or just walking, all relative sensor orientations become observable and can be accurately calculated.

An intuitive explanation for this property is the following: if one fixes the initial condition on orientation of one sensing unit, this results in a certain position trajectory of the sensing unit and, assuming known lever arms, a certain trajectory of its joint centers. The latter imposes in turn a relative position aiding for the adjoining sensing units. From GPS literature it is well known that under non-constant acceleration, position aiding results in completely observable sensor orientation. Hence, conditioned onto the orientation of the first sensing unit, the orientation of the adjoining sensing unit becomes observable, which is what is implied by observable relative sensor orientation. In other words, the orientation of all sensor units with respect to a common, though drifting frame can be consistently estimated without drift.

Note that this observability of relative orientation is obtained without relying on magnetometers to stabilize the orientation of every sensing unit, in particular the heading components. Moreover, the inertial motion capture system is formulated using the orientations of the sensor units only; the orientations of the segments are not part of it.

With this in mind, we turn to the question of lever arm calibration. It is important to note that the inertial motion capture problem previously described in detail contains redundant sources of information. Note that this redundancy results from the specific nature of the problem addressed; in other words, the use of a linked segment model wherein each segment includes an attached sensing unit results in redundant available information.

When the lever arms between sensing unit and corresponding segment origin are not a properly calibrated, this redundancy of available information may result in inconsistencies. However, these inconsistencies are easily seen when calculating specific motion tracking quantities, e.g., when calculating orientation and position trajectories of the sensing units. The quantities under discussion are not always relevant for the final application, which, for example, might require orientation and position trajectories of the body segments instead.

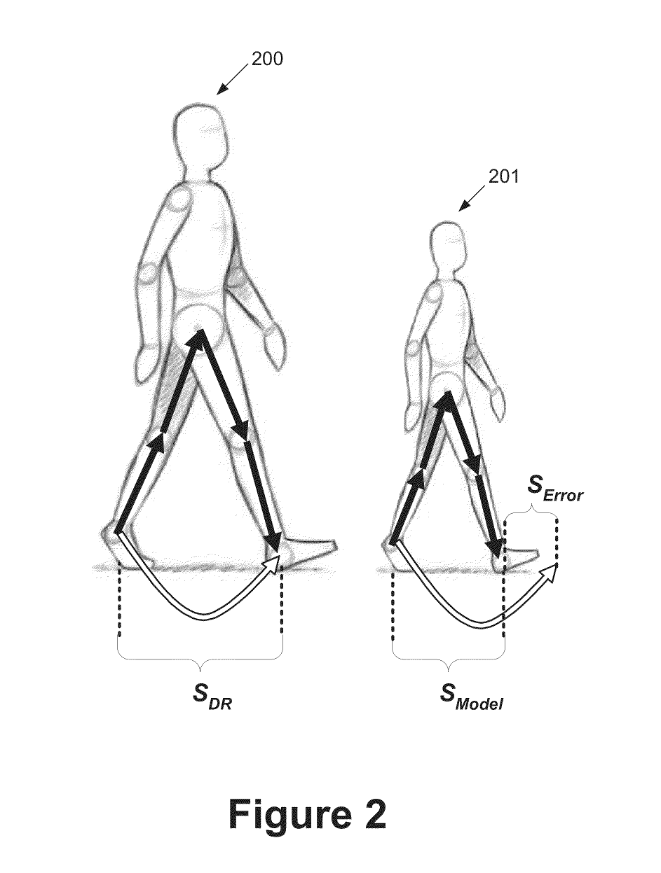

An example more clearly demonstrates the foregoing observation. Consider a subject 200, instrumented as above and walking This situation is shown in FIG. 2. In this example, the information of interest is the length S of the subject's stride. During walking, the subject's stride length S may be determined by dead-reckoning based on the data from the sensing unit on the subject's foot 105. This results in a first value of S=S_{DR}.

Alternatively, the subject's stride length can be independently determined from a vector sum of lever arms between sensing units and joints. The stride length S_{Model} calculated in this way should be consistent with the stride length S_{DR} calculated via dead-reckoning. However, if the lever arms are incorrect, as shown in the second rendering of the subject 201, these methods will not yield the same stride length. Indeed, as seen in the figure, the use of shorter-than-actual lever arms will result in a shorter-than-actual stride length and a mismatch S_{Error} between the accurate stride length S=S_{DR} and the erroneous stride length S_{Model}.

Following this observation, instead of treating the lever arms as constants with an a priori determined value, as is traditionally done, the method according to the described principles instead formulates a motion tracking problem in a way suited specifically to minimize this source of inconsistency. To this end, unknown 3D position vectors are introduced between each sensing unit and the joint centers of corresponding body segments, and the unknown 3D position vectors are estimated together with the sensing unit position and orientation trajectories over time.

In contrast to certain prior techniques, such as those described in U.S. Pat. No. 7,725,279, no translation of acceleration is needed; as such, the techniques described herein do not suffer from many of the limitations and problems of current techniques.

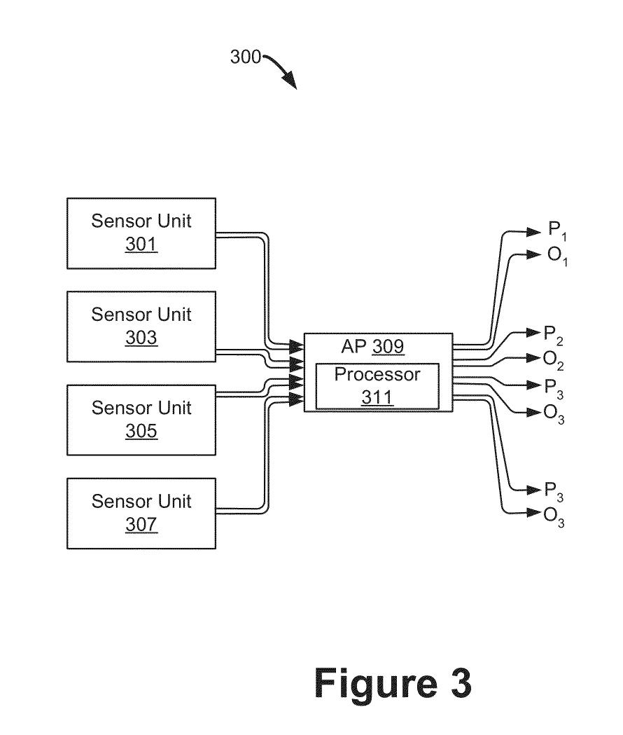

Before describing the example technique in further detail, a modular diagram of the sensor system is given to provide reference for the steps of the method. Thus, FIG. 3 shows an example configuration for a sensor system 300 for use with respect to embodiments of the described principles.

In the illustrated example, the sensor system includes a plurality of inertial measurement units (IMUs) 301, 303, 305, 307, which are sometimes also referred to as inertial sensor units. Each IMU 301, 303, 305, 307 generates a signal indicative of a sensed 3D angular velocity (change in orientation) and a signal indicative of a 3D acceleration (change in velocity). The angular velocity and the acceleration may be positive, zero or negative with a defined sensor range for each sensor type.

Each IMU 301, 303, 305, 307 provides the signals indicative of angular velocity and acceleration to a master unit or application processor (AP) 309. The AP 309 is a processor-driven unit (see processor 311) capable of managing data intake and output and of executing data manipulations such as integration and other manipulations that are discussed elsewhere herein.

Having received a signal indicative of change in orientation and a signal indicative acceleration from each of the IMUs 301, 303, 305, 307, the AP 309 converts the received data into an output consisting of multiple pairs of orientation and position estimates (Oₙ, Pₙ), one pair for each IMU 301, 303, 305, 307. It will be appreciated that an inertial motion tracking system may be implemented with a different architecture and/or a different number of IMUs 301, 303, 305, 307 than shown in FIG. 3. Moreover, those of skill in the art will be aware that the motion tracking process operations may take place at a single entity such as the AP 309 or across multiple entities, and may take place at the subject or remotely.

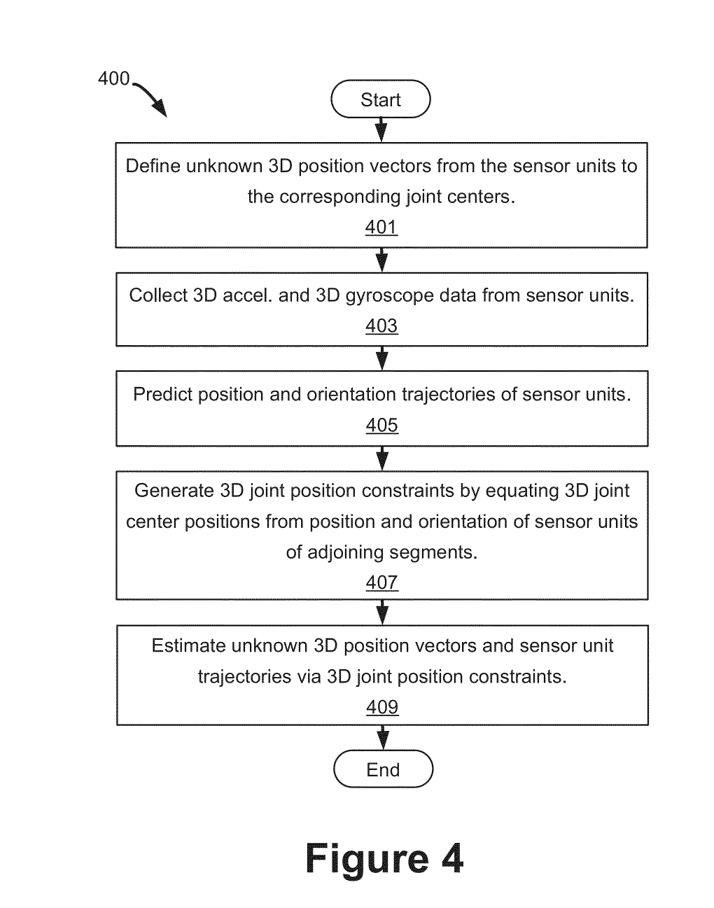

Although the described principles may be implemented in a variety of ways, an example process for lever arm calibration in accordance with an embodiment of the described principles is shown in FIG. 4. In particular, FIG. 4 shows a process 400 that estimates position vectors and trajectories using joint constraints in a multi-segment body of interest.

At stage 401 of the process 400, the processor 311 defines unknown 3D position vectors from the inertial sensing units 301, 303, 305, 307 to the corresponding joint centers. The processor 311 then collects 3D accelerometer and 3D gyroscope data from the sensing units 301, 303, 305, 307 at stage 403 and predicts position and orientation trajectories of the sensing units 301, 303, 305, 307 at stage 405 over time.

Subsequently at stage 407, the processor 311 generates 3D joint position constraints by equating the 3D joint center positions derived from the position and orientation of two sensing units attached to adjoining segments. Finally at stage 409, the processor 311 estimates the unknown 3D position vectors and the sensing unit trajectories by applying the 3D joint position constraints.

It is noted that the described lever arm calibration method uses the 3D accelerometer and 3D gyroscope signals for integration to position and orientation. Therefore, although generally applicable to the case in which angular velocity and acceleration signals are available, the method is especially well suited to accept signals pre-processed with SDI (strap down integration), i.e., orientation increments and velocity increments. Indeed, SDI reduces the output rate by retaining integral quantities such as position, velocity and orientation. However, SDI sacrifices the instantaneous angular velocity and acceleration signals which are required by the prior art; when SDI is performed, said instantaneous quantities can no longer be retrieved.

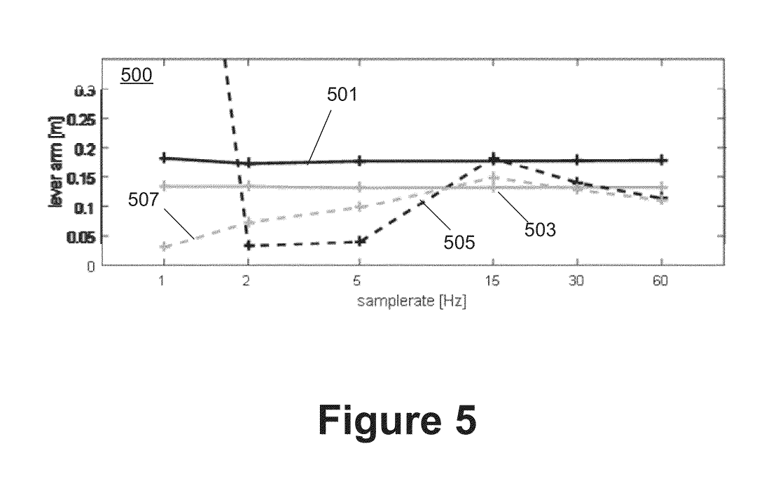

The performance of the method described herein is illustrated graphically in FIG. 5, which shows lever arm estimation results for the knee joint on a normal walking trial using SDI preprocessed measurements, as is common practice for commercially available wireless sensing units. The plot 500 includes four traces, namely the upper leg estimation 501 in accordance with the disclosed principles, the lower leg estimation 503 in accordance with the disclosed principles, the upper leg estimation 505 in accordance with the prior techniques, and the lower leg estimation 507 in accordance with the prior techniques.

It can be seen that the lever arm estimates calculated in accordance with the disclosed principles show consistent results independent of the used SDI rate (and are in line with ruler measurements of the measurement setup), whereas the prior method fails to give correct results, even for 60 Hz data. Note that 60 Hz is currently the maximum transmission rate of state-of-the-art commercially available full body inertial motion capture systems using wireless sensing units. Compared to the prior art, the compatibility with SDI opens new application areas including low-power, always on, wireless sensing devices since it allows a significant further reduction of the transmission rate resulting in improved performance with respect to wireless range or power consumption.

Using the described techniques, it is generally easy to observe the lever arms when small excitations in each degree of freedom of the joints are present. An intuitive explanation for this condition is that when two segments change orientation with respect to each other, their relative change in position will be coupled to the joint center position and hence to the lever arms. This in turn will allow the latter to be consistently observed. Note that for a (perfect) hinge joint, the joint center can lie anywhere on the (virtual) joint axis and hence the pair of lever arms are not uniquely defined. However, the (time varying) relative distance between the inertial sensing units remains observable in this case and hence motion capture performance is unaffected.

Those of skill in the art will appreciate that the described techniques can be extended to include other knowledge if available, e.g., a statistical scaling model of the human body, or data that a suit constrains sensing unit placement. The main benefit of doing so would be to increase robustness. This might be particularly beneficial in circumstances where there is insufficient excitation.

With respect to sensor-to-segment alignment calibration, in typical inertial motion tracking applications, the user is usually interested in body segment quantities rather than sensing unit quantities; for example 3D joint angles or segment orientation or position trajectories. For this reason, in order to translate sensor orientations to segment orientations, the sensor-to-segment alignments need to be determined. As described in previous sections, the prior art addresses this problem by relying on magnetometer readings to express the sensing unit orientations in a common frame, making this method not applicable in commonly occurring cases in which the magnetic field is not homogeneous.

The disclosed principles solve this problem by exploiting the fact that the sensing unit orientations can be tracked consistently over time without the specific alignment between sensing unit and corresponding body segment being known. This implies that adding additional information related to the segment orientations over time is sufficient to estimate the unknown sensor-to-segment alignments.

More specifically, since the sensing units' relative orientation trajectories are consistently tracked over time, a set of segment orientation constraints over time, either with respect to an external frame, or with respect to another segment frame, or with respect to a sensor frame, are sufficient to serve to the purpose. Since the number of unknowns which need to be solved are 3N, where N represents the number of sensing units attached to body segments, it is necessary to formulate at least 3N independent (one-dimensional) segment orientation constraints.

For the sake of reference, each of these (one-dimensional) segment orientation constraint can be more formally expressed as

f(Rₜ)=0,

where the function f:SO₃ⁿ→ [symbol] ¹ operates on a 3D segment orientation R at n (one or more) time instants t relative to another frame. As said, this other frame can be any of an external reference frame, a sensor frame, or another segment frame.

Segment orientation constraints can be derived from various sources or underlying physical principles, including, without limiting the applicability of the invention to these exemplary cases, specification of a segment orientation in an external frame at a given time instant, specification of a vector in two different segment frames or in a segment frame and in a sensor frame, specification of a joint angle pattern between two segments, etc.

To further illustrate the concept of independent segment orientation constraints, consider the case of a subject walking for a couple of gait cycles and then standing motionless in a known pose for a couple of seconds. The excitation during walking allows the orientations of the sensing units with respect to a common reference frame to be consistently estimated over time; this also holds during the motionless period.

At the same time, during the motionless period, the orientation of all N segments with respect to the reference frame (R_{known pose}) is known from the known pose. Combining both sources of information, the unknown sensor-to-segment alignments can be estimated for all segments. This can be more formally seen by observing that the set of segment orientation constraints during the motionless period can be formulated in this case as

RR_{known pose}⁻¹−I_{3×3}=0_{3×3}

for every segment. Note, this results in 9 one-dimensional segment orientation constraints per each segment; of these constraints, 3 are independent. Hence, the set of segment orientation constraints meets the requirement of 3N independent constraints previously described. Note again that in contrast to prior art this approach does not use magnetometers and as such functions in any magnetic environment, including heavily distorted ones.

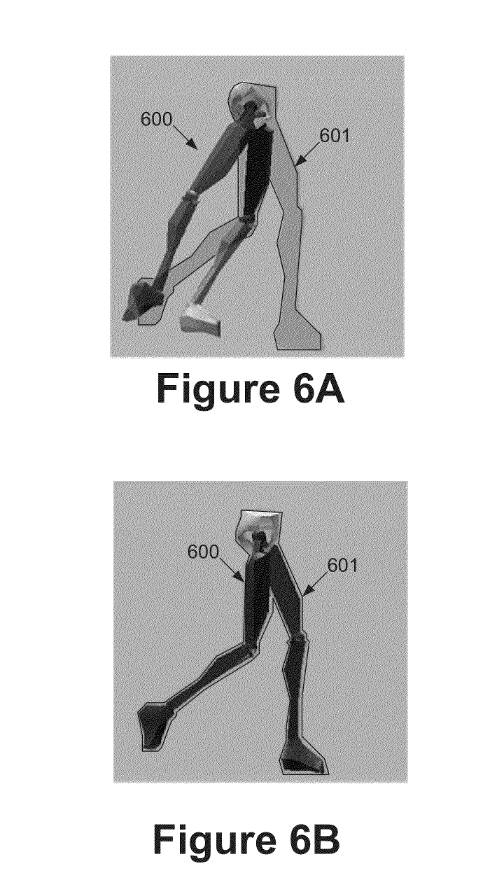

The performance of the disclosed sensor-to-segment calibration algorithm for this example is illustrated in FIGS. 6A and 6B. The FIG. 600 shows a pose estimate during normal walk, before (6A) and after (6B) calibration, including a transparent reference overlay 601 in FIG. 6A (before) and FIG. 6B (after). It can be seen that before calibration, the motion capture performance is very poor and the difference between the FIG. 600 and the reference overlay 601 is significant. This is a consequence of using incorrect sensor-to-segment alignments. After calibration (6B), accurate results are obtained since the sensor-to-segments have been correctly estimated.

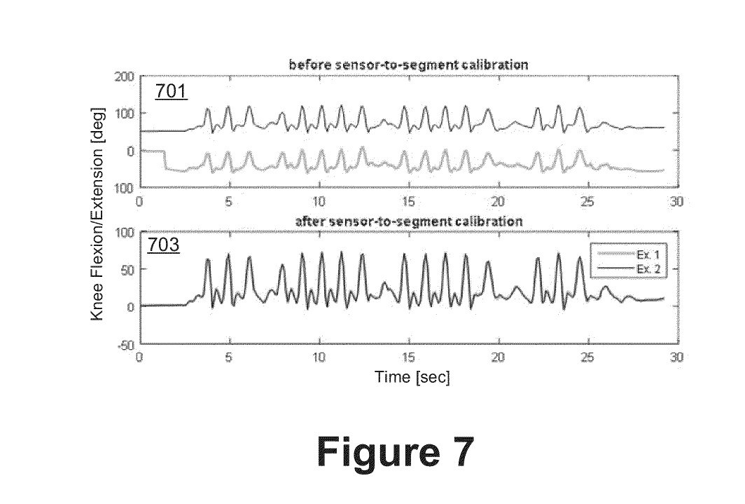

This behavior can also be seen in the joint angles labeled Ex. 1 in FIG. 7. From the figure it can be seen that the knee flexion/extension before calibration (plot 701) is incorrect, since as shown in plot 703, it suffers from a large offset among other things. After calibration, a normal gait pattern can be observed in plot 703.

To further illustrate the concept of independent segment orientation constraints, consider the case of N=2 segments, each with a sensing unit attached to it, and connected by a hinge joint, as for example a knee. Such a one dimensional joint defines an axis of rotation. From a dataset containing some excitation of the joint, the relative orientation of the sensors can be determined; this implies that the axis of rotation can be resolved in both sensor frames. In this way it is possible to introduce constraints which define the z-axis of each of the two segments (v_{z-axis}) to be the axis of rotation (v_{axis of rotation}). These constraints can be formulated as

Rv_{axis of rotation}−v_{z-axis}=0_{2×1}

for each segment. Note that this results in three one-dimensional segment orientation constraints per segment, of which only two constraints are independent.

To meet the independence criterion of 3N=6 independent segment orientation constraints and obtain a complete sensor-to-segment definition, it is possible to further define the y-axis of both segments (v_{y-axis}) to be orthogonal to the joint lever arm (v_{lever arm}). This constraint can be formulated as:

v_{y-axis}Rv_{lever arm}=0_{1×1}

for each segment. Note that in contrast to prior art this approach does not depend on the magnetic environment, nor does it depend on the subject assuming a prescribed pose.

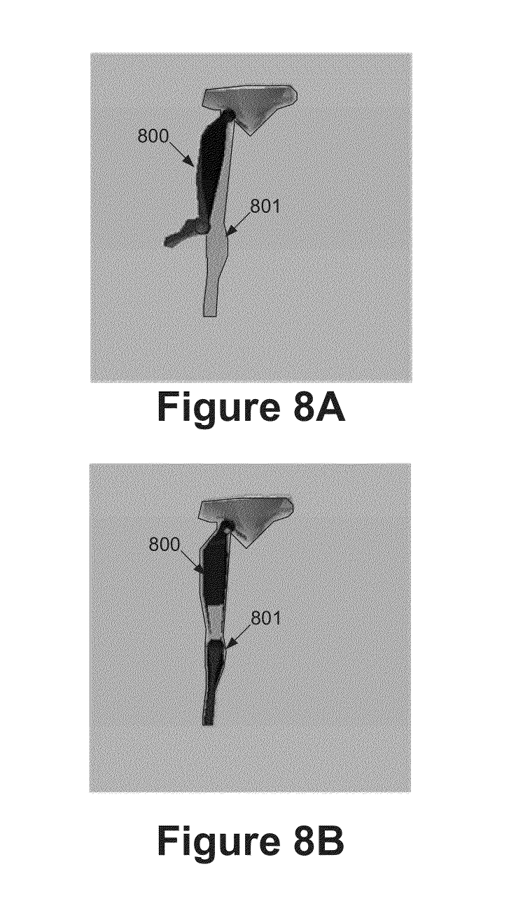

The performance of the proposed sensor-to-segment calibration algorithm for this example is illustrated in FIG. 8. The figure shows a pose estimate 800 during normal walk, before (8A) and after calibration (8B), including a transparent reference overlay 801. It can be seen that before calibration, the motion capture performance is very poor. This is a consequence of using incorrect sensor-to-segment alignments. After calibration, accurate results are obtained since the sensor-to-segments have been correctly estimated. This behavior can also be seen in the joint angles, see the lines labeled Ex. 2 in FIG. 7. After calibration (plot 703), a normal gait pattern can be observed, in contrast to before calibration (plot 701). Note that the calibrated results match those of the previous example.

It will be appreciated that alternative formulations of segment orientation constraints are possible. For example, the sensor-to-segment alignments of both segments can be defined by specifying the 3D joint angle between the segments to have a certain pattern in time. In case the joint has a single degree of freedom, as for example a hinge joint, a natural option is to impose two components of the joint angle be equal to zero.

I_{2×3}jointAngle(R)=0_{2×1}

for at least two time instants with different poses. Due to the single degree of freedom of the joint, this results in a set segment orientation constraints with only four independent entries. To meet the independence criterion of 3N=6 independent segment orientation constraints and obtain a complete sensor-to-segment definition, it is possible to additionally define the y-axis of each segment to be orthogonal to the joint lever arm, as discussed above. Although resulting in different types of segment orientation constraints, this alternative sensor-to-segment definition leads to similar calibration results.

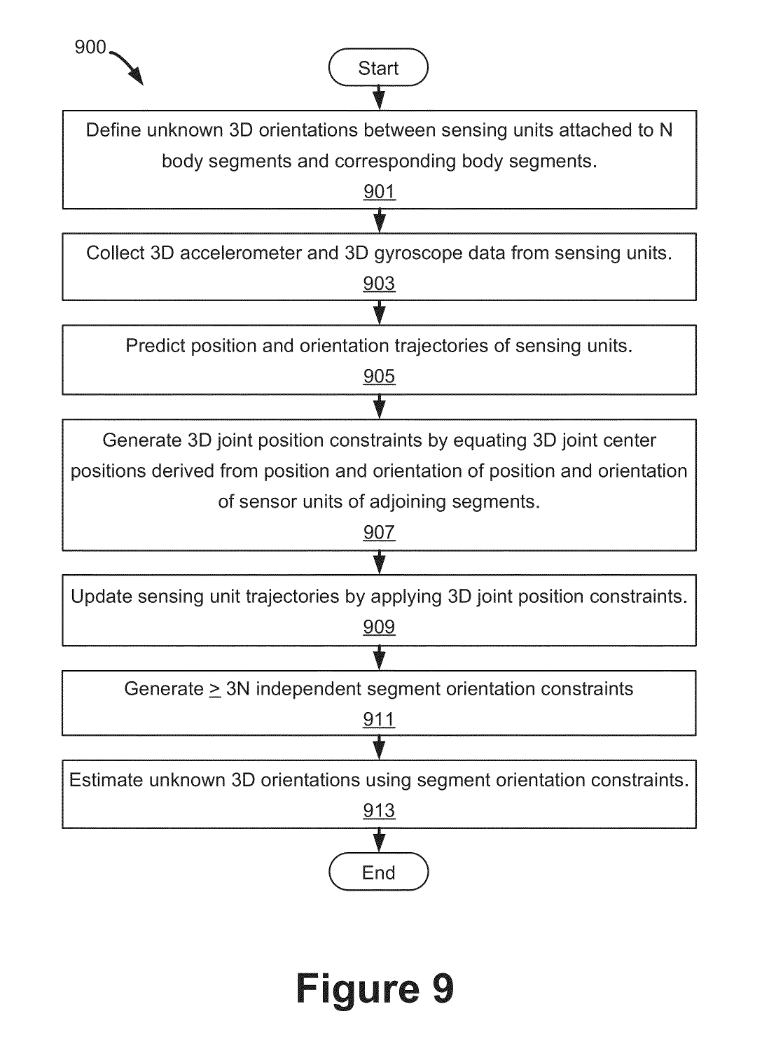

Continuing, the flowchart of FIG. 9 illustrates a process 900 corresponding to an exemplary implementation of the described method. At stage 901 of the process 900, the processor 311 defines unknown 3D orientations between sensing units attached to N body segments and their corresponding body segments. At stage 903, the processor 311 collects 3D accelerometer and 3D gyroscope data from the sensing units.

The position and orientation trajectories of the sensing units are predicted by the processor 311 at stage 905, and 3D joint position constraints are generated by equating the 3D joint center positions derived from the position and orientation of two sensing units attached to adjoining segments at stage 907. The sensing unit trajectories are updated at stage 909 by applying the 3D joint position constraints.

Subsequently the processor 311 generates a set of at least 3N independent segment orientation constraints at stage 911, each constraint being a scalar function operating on a 3D orientation of a segment at one or more time instants. Finally, the processor 311 estimates the unknown 3D orientations using the segment orientation constraints at stage 913.

As noted above, those of skill in the art will appreciate that the described techniques can be straightforwardly extended to include other constraints, e.g., a known placement of the sensing units based on use of a suit that constrains sensing unit placement.

It will be appreciated that in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method of inertial motion capture calibration with respect to a subject having N segments connected by joints, wherein N>1 and each segment has affixed at least one sensing unit, each sensing unit containing at least a 3D gyroscope and a 3D accelerometer, the method comprising:
defining unknown 3D orientations between sensing units and the corresponding segments the sensing units are attached to;
collecting 3D accelerometer and 3D gyroscope data from the sensing units;
predicting 3D position and 3D orientation trajectories of the sensing units by integration of the 3D accelerometer and 3D gyroscope data;
deriving 3D joint center positions from the predicted position and orientation of the sensing units;
generating 3D joint position constraints by equating pairs of 3D joint center positions derived from sensing units on adjoining segments;
updating the sensing unit trajectories by applying the 3D joint position constraints;
generating a set of at least 3N independent segment orientation constraints, each constraint being a scalar function operating on a 3D orientation of a segment at one or more time instants; and
estimating the unknown 3D orientations by applying the segment orientation constraints.

2. The method in accordance with claim 1, wherein the subject is a human body or part of a human body.

3. The method in accordance with claim 1, wherein the subject comprises at least one of an object and a mechanical structure.

4. The method in accordance with claim 1, wherein the joints include at least one of hinge joints and ball-and-socket joints.

5. The method in accordance with claim 1, wherein the 3D accelerometer and 3D gyroscope data comprise orientation and velocity increment signals obtained from pre-processing with SDI (strap down integration).

6. The method in accordance with claim 1, wherein any of the sensing units further include a 3D magnetometer.

7. The method in accordance with claim 1, wherein deriving 3D joint center positions from the predicted position and orientation of the sensing units comprises translating predicted sensing unit positions by known 3D position vectors rotated using the predicted sensing unit orientations.

8. The method in accordance with claim 1, wherein the 3D orientation of segments in the segment orientation constraints are relative to any of an external reference frame, a sensor frame, or another segment frame.

9. The method in accordance with claim 1, wherein estimating the unknown 3D orientations further includes using additional known constraints.

10. A method of inertial motion capture calibration with respect to a subject having multiple segments connected by joints, wherein each segment has affixed at least one sensing unit, each sensing unit containing at least a 3D gyroscope and a 3D accelerometer, the method comprising:
defining unknown 3D position vectors from the sensing units to corresponding joint centers;
collecting 3D accelerometer and 3D gyroscope data from the sensing units;
predicting position and orientation trajectories of the sensing units by integration of the 3D accelerometer and 3D gyroscope data;
generating 3D joint position constraints by equating 3D joint center positions derived from the predicted position and orientation of two sensing units attached to adjoining segments and the unknown 3D position vectors; and
estimating the unknown 3D position vectors and the sensing unit trajectories by applying the 3D joint position constraints.

11. The method in accordance with claim 10, wherein estimating the unknown 3D position vectors and the sensing unit trajectories further includes using additional known constraints on the 3D position vectors.

12. A system of inertial motion capture calibration with respect to a subject having N segments connected by joints, wherein N>1, the system comprising:
at least one sensing unit affixed to each segment, each sensing unit containing at least a 3D gyroscope and a 3D accelerometer; and
a controller configured to:
define unknown 3D orientations between sensing units and the corresponding segments the sensing units are attached to;
collect 3D accelerometer and 3D gyroscope data from the sensing units;
predict 3D position and 3D orientation trajectories of the sensing units by integration of the 3D accelerometer and 3D gyroscope data;
derive 3D joint center positions from the predicted position and orientation of the sensing units;
generate 3D joint position constraints by equating pairs of 3D joint center positions derived from sensing units on adjoining segments;
update the sensing unit trajectories by applying the 3D joint position constraints;
generate a set of at least 3N independent segment orientation constraints, each constraint being a scalar function operating on a 3D orientation of a segment at one or more time instants; and
estimate the unknown 3D orientations by applying the segment orientation constraints.

13. The system in accordance with claim 12, wherein the subject is part of a human body.

14. The system in accordance with claim 12, wherein the subject comprises at least one of an object and a mechanical structure.

15. The system in accordance with claim 12, wherein the joints include at least one of hinge joints and ball-and-socket joints

16. The system in accordance with claim 12, wherein the 3D accelerometer and 3D gyroscope data comprise orientation and velocity increment signals obtained from pre-processing with SDI (strap down integration).

17. The system in accordance with claim 12, wherein any of the sensing units further include a 3D magnetometer.

18. The system in accordance with claim 12, wherein the segment orientation constraints are formulated using a segment orientation relative to any of an external reference frame, a sensor frame, or another segment frame.

19. A non-transitory computer-readable medium having stored thereon computer-executable instructions for performing inertial motion capture calibration with respect to a subject having N segments connected by joints, wherein N>1, with at least one sensing unit affixed to each segment, each sensing unit containing at least a 3D gyroscope and a 3D accelerometer, the computer-executable instructions comprising:
defining unknown 3D orientations between sensing units and the corresponding segments to which the sensing units are attached;
collecting 3D accelerometer and 3D gyroscope data from the sensing units;
predicting 3D position and 3D orientation trajectories of the sensing units by integration of the 3D accelerometer and 3D gyroscope data;
deriving 3D joint center positions from the predicted position and orientation of the sensing units;
generating 3D joint position constraints by equating pairs of 3D joint center positions derived from sensing units on adjoining segments;
updating the sensing unit trajectories by applying the 3D joint position constraints;
generating a set of at least 3N independent segment orientation constraints, each constraint being a scalar function operating on a 3D orientation of a segment at one or more time instants; and
estimating the unknown 3D orientations by applying the segment orientation constraints.

20. The non-transitory computer-readable medium in accordance with claim 19, wherein the subject includes part of a human body.

21. The non-transitory computer-readable medium in accordance with claim 19, wherein the subject comprises at least one of an object and a mechanical structure.

22. The non-transitory computer-readable medium in accordance with claim 19, wherein the joints include at least one of hinge joints and ball-and-socket joints.

23. The non-transitory computer-readable medium in accordance with claim 19, wherein the 3D accelerometer and 3D gyroscope data comprises orientation and velocity increment signals obtained from pre-processing with SDI (strap down integration).

24. The non-transitory computer-readable medium in accordance with claim 19, wherein any of the sensing units further includes a 3D magnetometer.

25. The non-transitory computer-readable medium in accordance with claim 19, wherein the instructions for generating a set of at least 3N independent segment orientation constraints comprise instructions for generating the set of at least 3N independent segment orientation constraints using a segment orientation relative to any of an external reference frame, a sensor frame, or another segment frame.
